(19) United States
(12) Patent Application Publication
(10) Pub. No.: US 2012/0265651 A1
(43) Pub. Date: Oct. 18, 2012

(54) METHOD AND SYSTEM FOR THE REMOTE EVALUATION AND PURCHASE OF GOODS

(76) Inventor: David Samuel EPHRAIM, Melbourne Beach, FL (US)

(21) Appl. No.: 13/087,530

(22) Filed: Apr. 15, 2011

(51) Int. Cl. G06Q 30/00

(52) U.S. Cl. 705/27.2

(57) ABSTRACT

A system for the remote evaluation and purchase of goods, comprising a remote buyer, a communication network, and a device for evaluation and purchase of goods that is configured to establish communication between a seller and a remote buyer using the communication network, assist the buyer in examining the one or more items for sale, assist the buyer and seller to establish the terms of a sale, assist the seller in transferring the one or more items to the buyer, and provide payment to the seller.

### BACKGROUND

Presently, several options exist for a person intending to sell an item such as jewelry, precious metals, gemstones, coins, collectibles, or similar items. Often, they can be sold at jewelry stores, pawnshops, coin stores, hotel shows, or other similar venues. They can also be sold through the mail to precious metal brokers or other businesses that advertise on television and elsewhere.

In-person purchasing allows the seller to ascertain the terms of the sale before relinquishing control of the item. However, the costs associated with operating a physical store are high, and overhead associated with long periods of time in which the buyer sits idle waiting for a seller to appear wastes money and forces purchase offers to be less competitive to cover costs. Mail-in purchasing requires a leap of faith from sellers as they are unable to determine the price at which their items will be purchased until well after they have relinquished control of them by placing them in the mail.

### SUMMARY

In one exemplary embodiment, a system for the remote evaluation and purchase of goods may be described. The system can include a remote buyer, a communication network, and a device for evaluation and purchase of goods, that can be configured to establish communication between a seller and the remote buyer using the communication network, assist the buyer in examining the one or more items for sale, assist the buyer and seller to establish the terms of a sale, assist the seller in transferring the one or more items to the buyer, and provide payment to the seller.

In another exemplary embodiment, a method for the remote evaluation and purchase of goods is disclosed. The method can include establishing communication between a buyer and a remote seller, evaluating one or more items for sale using remote sensors, establishing the terms of a sale, providing a means for the seller to transfer the one or more items to the buyer, and paying the seller for the one or more items sold.

In another exemplary embodiment, an apparatus for the remote evaluation and purchase of goods is disclosed. The apparatus can include a communication device, a display, at least one camera, a microphone and at least one speaker, a scale, a receptacle configured to securely store one or more items, and a device configured to dispense payment.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a front view of an exemplary embodiment of a device for the remote evaluation and purchase of goods.

FIG. 2 is a diagram representing an exemplary method of remotely evaluating and purchasing goods.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation. Also, “data” should be understood to be any information in either organized or unorganized form and in any format.

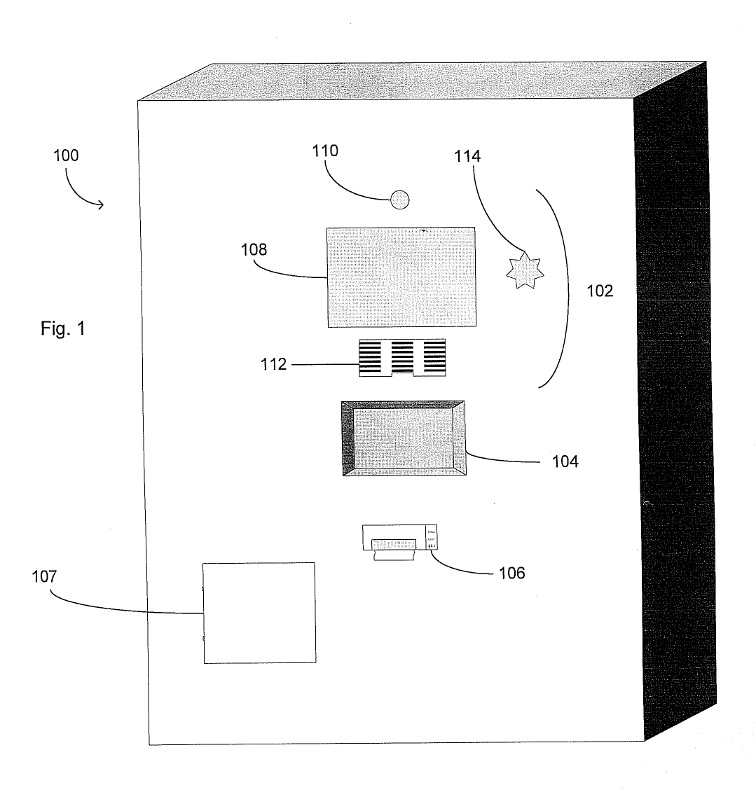

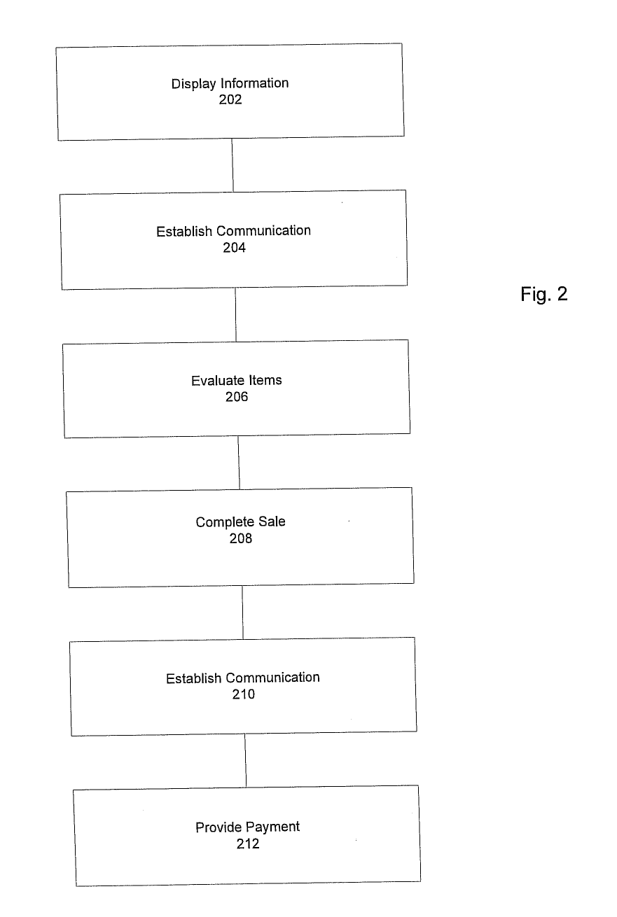

FIGS. 1 and 2 generally refer to exemplary embodiments of a device for the remote evaluation and purchase of goods. In exemplary embodiments, the device can have capabilities for communication between a buyer and seller, examination and evaluation of a good or goods offered for sale, and payment for the good or goods. The goods able to be evaluated and purchased by this device can include, but are not limited to, jewelry, precious metals, coins, gemstones, and collectibles.

As shown in exemplary FIG. 1, and in some exemplary embodiments, device 100 can include an interface, such as seller interface area 102. Seller interface area 102 can be used to communicate with a potential seller. Seller interface area 102 can include visual display 108, which can be a television screen, monitor, or any other type of visual display which can be used to display a remote buyer to a seller. Seller interface 102 can also include a camera 110 which can be used to transmit video or images of a seller to a remote buyer. Further, seller interface area 102 can have audio communication device 114, which may include any combination of a microphone, speakers, or a handset. As described herein, audio communication device can be used for audio communication between a seller and a remote buyer. Additionally, seller interface area 102 can include manual interaction device 112, which may be, for example, a keyboard, mouse, touch screen, track pad, electronic writing instrument, or any type of data entry device which can be used by a seller to enter data or make selections. Seller interface area 102 can further include a fingerprint scanner.

Still referring to exemplary FIG. 1, seller interface area 102 can also include a document scanner, which can be used to accept and record certificates, identification, or any other type of documents which can be presented by a seller. Additionally, seller interface area 102 can include a magnetic stripe reader which can be used to read identification cards, credit cards, debit cards, automatic teller machine cards, or any other object that includes a coded magnetic stripe. Seller interface area 102 can also have any desired provisions for communicating with a remotely located seller using Radio-Frequency Identification (RFID), Near-Field Communication (NFC), Wireless Internet, Bluetooth, Short Message Service (SMS), Multimedia Message Service (MMS), email, or any other method of electronic communication. Seller interface area 102 can include provisions for communicating with cellular telephones or any other mobile communication device as well. These and any other desired forms of audio, visual or data communication may be provided in interface area 102 or otherwise on device 100.

Still referring to exemplary FIG. 1, in some exemplary embodiments, remote evaluation and purchase device 100 can also include item analysis area 104. Item analysis area 104 can include one or more sensors that can be used by a remote buyer to evaluate an item that can be presented by a seller, for example to determine a proposed monetary value. Item analysis area 104 can include imaging sensors, for instance still or video cameras or scanners, with or without zoom capabilities, as desired. Item analysis area 104 can also contain weight sensors, for instance scales optimized for the evaluation of gold or other precious metals, scales optimized for the evaluation of diamonds or other gemstones, or scales optimized for the evaluation of other objects such as silverware. Item analysis area 104 can also include tools and sensors that can assess the quality or authenticity of an item. For example, item analysis area 104 can include a magnetic sensor, which can assist in determining if an item is composed of certain precious metals. In another example, item analysis area 104 can include a mineral purity tester, for example, to evaluate the purity of an item or mineral, placed in the area. Such testers can include, but are not limited to, x-ray fluorescence spectrometers that can detect and analyze metals such as gold, silver, platinum, palladium, rhodium, ruthenium, copper, zinc, nickel, cadmium, indium, and the like. Item analysis area 104 can also include any type of electronic testing, for instance electronic precious metals testing or electronic gemstone testing. In still further embodiments, item analysis area 104 can be such that the type of evaluation may be switched by a seller using interface 102 or remotely by a buyer.

In further exemplary embodiments of FIG. 1, remote evaluation and purchase device 100 can have payment area 106. Payment area 106 can include provisions for providing one or more types of payment to a seller for an item. In some embodiments, payment area 106 can include provisions for printing a check payable to the seller. Payment area 106 can also, in some embodiments, dispense payment in the form of cash. Payment area 106 can also dispense coupons or vouchers for conditional payment, payment of some portion of an agreed-upon sale price, or payment at a location separate from device 100. Different forms of payment can be selected by a buyer, or by a seller using interface 102. However, it may be appreciated that any form of payment or credit may be provided from a buyer, through device 100, to a seller.

Still referring to exemplary FIG. 1, in some embodiments, remote evaluation and purchase device 100 can have item storage area 107. Although shown as a separate area in exemplary FIG. 1, item storage area 107 may be integrated with item analysis area 104 so as to allow for an item to be evaluated and then stored at any desired time thereafter. For example, item analysis area 104 may include a manually or automatically activated door which can accept items that may then be housed in item storage area 107.

Thus, item storage area 107 can provide a secure storage location for items that have been sold or that potentially will be sold. Item storage area 107 can be a safe, strongbox, lockbox, vault, drop box, or any other type of secure storage device. Further, item storage area 107 can have a door, drawer, or any other type of opening which can be opened at a predetermined point in a transaction, at the direction of a remote buyer, or at the direction of a seller, using for instance seller interface area 102. A seller can deposit an item in item storage area 107 at the conclusion of a sale, after payment has been distributed, or at any other time in a transaction. The opening of item storage area 107 can be secured immediately, manually or automatically, after an item has been deposited, at some predetermined time during a transaction, at the direction of a remote buyer, or at the direction of a seller, using for example seller interface area 102, or at any other time during or at the conclusion of a transaction. Item storage area 107 can be adapted to store one or more items separately, allowing previously deposited items to remain secure while new items are deposited. Items can be retrieved from item storage area 107 by a buyer or a representative of a buyer at any time after the close of a transaction. Item storage area 107 can be adapted to store one or more items separately, for example through mechanical separation, allowing a buyer or representative of a buyer to retrieve one or more items while other items remain secure. Additionally, item storage area 107 may be capable of sorting or storing areas based upon a desired form of data, such as the type, size or value of an item.

Seller interface area 102, item analysis area 104, payment area 106, and item storage area 107 can be contained in a single structure, however they need not be. For example, in some exemplary embodiments seller interface area 102, item analysis area 104, payment area 106, and item storage area 107 can be located in one or more separate enclosures or structures. In other exemplary embodiments, any one of, or any combination of, seller interface area 102, item analysis area 104, payment area 106, or item storage area 107 can be located in the inside or outside wall of building or other structure. In any configuration, remote evaluation and purchase device 100 can be placed in any desired area, for instance as kiosk installations at malls, banks, stores, or any other location.

In still a further exemplary embodiment, item analysis area 104 may include a coin counting or sorting mechanism. For example, coins may be placed in item analysis area 104 for an analysis of their weight, type and characteristics. In some situations where there may be a large number of coins and it may be difficult to count them based on still or video images, it may be desirable to have device 100 count the coins. Thus, after the coins are analyzed (or at any other desired time), the coins may be manually or automatically placed into a counting mechanism located in or near item analysis area 104. The coins may then be counted and/or sorted. After the coins are counted and sorted, they may be returned to item analysis area 104 or, in other exemplary embodiments, may be stored in item storage area 107. In still further exemplary embodiments, a coin sorting and counting mechanism may be capable of binding or otherwise grouping like coins, as desired. In still other exemplary embodiments, device 100 may be capable of counting, sorting and storing any amount of coins without first analyzing them. Additionally, device 100 may be capable of determining the value of any coins and providing a payment corresponding to such value.

Turning to exemplary FIG. 2, when device 100 is not in use or is otherwise idle, seller interface area 102 can display advertisements at step 202. Seller interface area 102 can display any advertisements, for instance how much a particular buyer pays for various goods, why a particular buyer is superior to other buyers or services, or any other advertisement for any other goods or services. At step 204, a seller can use seller interface area 102 to interact with a buyer. The interaction can take place through a public or private telephone network, the internet, or any other desired communication network. The interaction can take the form of videoconferencing, teleconferencing, audio, text, or any other type of communication, for example using components of interface area 102 described previously. Additionally, upon approaching device 100, seller interface area 102 may display instructions for using device 100 or otherwise provide information to a user or potential seller.

Still referring to exemplary FIG. 2, at step 206, a potential seller can present an item for sale to a buyer using item analysis area 104. A buyer can remotely use any sensors present in item analysis area 104 to evaluate an item for sale by determining its size, weight, shape, appearance, condition, authenticity, or any other attribute, as desired. The evaluation may include the determination of a price at which a remotely located buyer may be willing to purchase the item. Additionally, the evaluation may include a price that the device 100 automatically sets based upon any desired attributes of the item in item analysis area 104 and at which the machine may automatically prompt a potential seller that it would be willing to purchase the item. Also, in some further exemplary embodiments, at any point during an interaction between a remotely located buyer and a potential seller at device 100, the buyer and potential seller can use seller interface area 102, using the aforementioned components of seller interface 102, to discuss an item and negotiate terms of a potential sale.

If a buyer determines (or, in some exemplary embodiment, the device 100 makes an automatic determination) to buy an item, at step 208 device 100 can be used to complete the sale. A buyer can ask a seller to use seller interface area 102 to scan an identification card, scan a fingerprint, provide a signature, provide identifying data or fulfill any other requirements necessary or desired for a sale. At this step, a seller can enter into a sale agreement with a buyer, certifying for example that the goods being sold are not stolen, and that the seller has agreed to sell them at a certain price, or under certain conditions. For example, in some situations it may be desirable to have a seller provide credit card information to the buyer through device 100 to act as potential security against the sale of fraudulent or stolen goods.

At step 210, a seller can deposit the item to be sold, for example in item storage area 107, and it may then be secured in device 100, for example for later collection. In some other exemplary embodiments, in step 210 the seller may effectively transfer the item to the buyer, in any desired manner. For example, the seller could package the item to be sold in order to transfer it to a buyer. The item can be shipped to the buyer using a shipping container that can be made available to the seller, the item can be stored within device 100, or a list of one or more locations at which the item can be deposited can be made available to the seller.

At step 212, payment can be made to a seller. Payment area 106 can be can be used to dispense money to the seller. Payment area 106 can be used to dispense cash or print a check, voucher, or coupon for the seller. The check, voucher, or coupon can be immediately redeemable by the seller, or it can be conditional based on subsequent evaluation of the item sold, or any other conditions agreed to by a buyer and seller. In other exemplary embodiments, payment can be subsequently mailed to a seller, or it can be made at a different location, for instance after a seller has deposited the item sold. If payment is not immediately provided, it can be placed in escrow, which can help improve seller confidence and protect against fraud.

Referring to both FIGS. 1 and 2, and by way of a non-limiting example, consider a potential seller who wishes to sell a diamond ring. At step 202, the seller can encounter a device 100 in the form of, for example, a kiosk located in the walkway of a shopping mall. The seller can take note of the advertisement displayed on seller interface area 102 and decide to engage a buyer. At step 204, the seller can use the display 108, camera 110, microphone and speakers 114, and a manual interaction device 112 in the form of a keyboard in order to contact a remote buyer and engage in preliminary discussions.

At step 206, the buyer can remotely control various devices located in item analysis area 104, or can use seller interface area 102 to direct the seller in conducting tests and observe the results. The tests may be conducted using any known tools which may be disposed in device 100 and may include any of a variety of different types of tests. For example, the density of the ring can be determined by weighing and measuring it, conducting a spectro-analysis, or by submerging it in a liquid and measuring displacement. The seller can compare this density to known densities of different metals to assist in determining the identity and grade of the metal in the ring. The metal in the ring can also be evaluated using magnetic sensors. In some other exemplary embodiments, where a gemstone, such as a diamond, is included in the ring, the gemstone can be tested using temperature-based or refraction-based gemstone testers in order to determine the identity and grade of the gemstone in the ring.

Using the results of the examination, the buyer can, at step 208, use seller interface area 102 to negotiate the terms of the sale. The buyer and seller can negotiate price and agree on any desired contingency options should subsequent examination by the buyer reveal a problem. Once the terms of the sale have been agreed upon, the buyer and seller can use seller interface area 102 to complete the sale by collecting a signature from the seller on an electronic signature pad.

At step 210, the buyer can direct a secure drawer located in item storage area 107 to open. Seller can deposit the ring in the drawer. The door of the drawer may then be automatically closed and locked, securing the ring, or any other item, deposited therein. Once the item is secure, the buyer at step 212 can place funds corresponding to the price of the ring in an escrow account and can direct payment area 106 to print an agreed-upon conditional voucher to the seller, or provide payment in any of the other above-described manners. The buyer can then subsequently retrieve the ring from item storage area 107, perform a more thorough inspection, and, once satisfied, can release the funds in escrow to be retrieved by the seller using the voucher.

In another non-limiting example, and still referring to both FIGS. 1 and 2, consider a potential seller who wishes to sell a gold ring or gold chain. At step 202, the seller can encounter a device 100 installed, for example, in the inside wall of a retail store. The seller can take note of the advertisement displayed on seller interface area 102 and decide to engage a buyer. At step 204, the seller can use the display 108, camera 110, microphone and speakers 114, and a manual interaction device 112 in the form of a keyboard in order to contact a remote buyer and engage in preliminary discussions.

At step 206, the buyer can remotely control various devices located in item analysis area 104. For example, the amount of gold in the ring or chain can be determined using a scale located in item analysis area 104. A camera located in item analysis area 104 can be used to examine the ring or chain, and can zoom in to see any etchings or markings on the ring, or to see whether the links in the chain are well fitted or properly assembled.

Using the results of the examination, the buyer can, at step 208, use seller interface area 102 to negotiate the terms of the sale, for example price. Once the terms of the sale have been agreed upon, the buyer and seller can use seller interface area 102 to complete the sale by collecting a signature from the seller on an electronic signature pad.

At step 210, the buyer can direct a door located in item storage area 107 to open. Seller can deposit the ring or the chain into item storage area 107. The door may then be automatically closed and locked, securing the ring or chain. Once the item is secure, the buyer at step 212 can direct payment area 106 to dispense cash in the amount of the agreed-upon value of the ring or chain. The buyer can then subsequently retrieve the ring or chain from item storage area 107.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for the remote evaluation and purchase of goods, comprising:
a remote buyer;
a communication network; and
a device for evaluation and purchase of goods configured to establish communication between a seller and a remote buyer using the communication network, facilitate the examination of the one or more items for sale, facilitate the buyer and seller to establish the terms of a sale, facilitate the seller in transferring the one or more items to the buyer, and provide payment to the seller.

2. The system of claim 1, wherein the communication between the buyer and the seller takes place using at least one of a still camera, a video camera, a microphone, a speaker, a keyboard, a mouse, a touch screen, a track pad, an electronic writing instrument, a document scanner, a magnetic stripe reader, and a mobile communication device.

3. The system of claim 1, wherein the evaluation takes place using at least one of a still camera, a video camera, a scanner, a weight sensor, a magnetic sensor, a spectrometer and an electronic testing sensor.

4. The system of claim 1, wherein facilitation of the transfer of the one or more items to the buyer further comprises providing a shipping container to the seller for the one or more items, storing the one or more items, or informing the seller of a location at which the one or more items can be deposited.

5. The system of claim 1, wherein the facilitation of providing payment to the seller further comprises at least one of providing money to the seller, printing a check payable to the seller, mailing a check payable to the seller, and printing a voucher conditionally payable to the seller.

6. A method for the remote evaluation and purchase of goods, comprising:
establishing communication between a buyer and a remote seller using a communication device;
evaluating one or more items for sale using remote sensors;
negotiating the terms of a sale using a communication device;
assisting the seller to transfer the one or more items to the buyer; and
paying the seller for the one or more items, sold.

7. The method of claim 6, wherein the communication device is at least one of a still camera, a video camera, a microphone, a speaker, a keyboard, a mouse, a touch screen, a track pad, an electronic writing instrument, a document scanner, a magnetic stripe reader, and a mobile communication device.

8. The method of claim 6, further comprising remotely evaluating at least one of a size, a weight, a shape, an appearance, a condition, and an authenticity of the one or more items.

9. The method of claim 6, wherein the evaluation takes place using at least one of a still camera, a video camera, a scanners, a weight sensor, a magnetic sensor, and an electronic testing sensors.

10. The method of claim 6, further comprising securely storing the one or more items at the point of sale.

11. The method of claim 6, further comprising at least one of:
providing money to the seller;
printing a check payable to the seller;
mailing a check payable to the seller; and
printing a voucher conditionally payable to the seller;

12. An apparatus for the remote evaluation and purchase of goods, comprising:
a communication device;
a display;
at least one camera;
at least one microphone;
at least one speaker;
an evaluation area;
at least one sensor;
a receptacle configured to securely store one or more items; and
a device configured to dispense payment.

13. The apparatus of claim 12 wherein the communication device is connected to a communication network and is configured to transmit audio data, visual data, and data related to physical qualities of an item placed in the evaluation area to a remote user.

14. The apparatus of claim 12, further comprising at least one of a keyboard, a mouse, a touch screen, a track pad, an electronic writing instrument, a document scanner, a magnetic stripe reader, and a mobile communication device.

15. The apparatus of claim 12, wherein the at least one sensor comprises at least one magnetic sensor or electronic testing sensors.

16. The apparatus of claim 15, wherein the at least one sensor comprises a spectrometer.
